(19) United States
(12) Patent Application Publication
(10) Pub. No.: US 2025/0306751 A1
(43) Pub. Date: Oct. 2, 2025

(54) ELECTRONIC DEVICE FOR IDENTIFYING EXTERNAL OBJECT WHILE PROJECTING SCREEN, AND METHOD THEREFOR

(71) Applicant: SAMSUNG ELECTRONICS CO., LTD., Gyeonggi-do (KR)

(72) Inventors: Kihyoung SON, Suwon-si (KR); Jiyeon Ma, Suwon-si (KR); Jingun Jung, Suwon-si (KR); Sungjun Hwang, Suwon-si (KR); Youngah Lee, Suwon-si (KR)

(73) Assignee: SAMSUNG ELECTRONICS CO., LTD., Gyeonggi-do (KR)

(21) Appl. No.: 19/237,735

(22) Filed: Jun. 13, 2025

Related U.S. Application Data
(63) Continuation of application No. PCT/KR2023/016193, filed on Oct. 18, 2023.

(30) Foreign Application Priority Data
Dec. 13, 2022 (KR) 10-2022-0174055

(51) Int. Cl. G06F 3/0488; G06F 3/01; G06F 3/0484; H04N 9/31

(52) U.S. Cl. CPC G06F 3/0488; G06F 3/0484; H04N 9/3179; G06F 3/011

(57) ABSTRACT

An electronic device includes: an interface; a camera; a projection assembly; memory comprising one or more storage media storing instructions and at least one processor comprising processing circuitry, wherein the instructions, when executed by the at least one processor individually or collectively, cause the electronic device to: project, by controlling the projection assembly, a screen obtained through the interface; activate, in a state of projecting the screen receiving an identification of a contact point on a surface at a displaying area formed by the projection assembly, the camera positioned toward a second direction different from a first direction of the projection assembly; and based on identifying an external object from information obtained using the activated camera and based on a location of the external object with respect to the surface, change a size of the screen.

### CROSS-REFERENCE TO RELATED APPLICATIONS

This application is a by-pass continuation application of International Application No. PCT/KR2023/016193, filed on Oct. 18, 2023, which is based on and claims priority to Korean Patent Application No. 10-2022-0174055, filed on Dec. 13, 2022, in the Korean Intellectual Property Office, the disclosures of which are incorporated by reference herein their entireties.

### BACKGROUND

### 1. Field

The present disclosure relates to an electronic device for identifying an external object while projecting a screen and a method therefore.

### 2. Description of Related Art

An electronic device for visualizing information has been developed. Examples of the electronic device are a television, a monitor, an electric board, a beam projector, a mobile phone, and a tablet PC. The electronic device may form a displaying area representing the information on one surface of the electronic device or one surface of the outside of the electronic device, such as a floor, a ground, a wall, or a screen.

### SUMMARY

According to an embodiment, an electronic device may comprise an interface, a camera, a projection assembly, memory comprising one or more storage media storing instructions, and at least one processor comprising processing circuitry. The instructions, when executed by the at least one processor individually or collectively, may cause the electronic device to project, by controlling the projection assembly, a screen obtained through the interface. The instructions, when executed by the at least one processor individually or collectively, may cause the electronic device to activate, in a state of projecting the screen receiving an identification of a contact point on a surface at a displaying area formed by the projection assembly, the camera positioned toward a second direction different from a first direction of the projection assembly. The instructions, when executed by the at least one processor individually or collectively, may cause the electronic device to change, based on identifying an external object from information obtained, using the activated camera, a size of the screen based on a location of the external object with respect to the surface.

According to an embodiment, a method of an electronic device may comprise projecting, by controlling a projection assembly, a screen obtained through an interface. The method of the electronic device may comprise activating, in a state projecting the screen requiring identification of a contact point on one surface at which a displaying area by the projection assembly is formed, a camera positioned toward a second direction different from a first direction of the projection assembly. The method of the electronic device may comprise changing, based on identifying an external object from information obtained using the activated camera, a size of the screen based on a location of the external object with respect to the surface.

According to an embodiment, in a computer readable storage medium storing one or more programs, the one or more programs, when executed by a processor of an electronic device, may cause the processor of the electronic device to project, by controlling a projection assembly, a screen obtained through an interface. The one or more programs, when executed by the processor of the electronic device, may cause the processor of the electronic device to activate, in a state projecting the screen requiring identification of a contact point on one surface at which a displaying area by the projection assembly is formed, a camera positioned toward a second direction different from a first direction of the projection assembly. The one or more programs, when executed by the processor of the electronic device, may cause the processor of the electronic device to change, in response to identifying an external object from information obtained using the activated camera, a size of the screen based on a location of the external object with respect to the surface.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of an electronic device projecting a screen according to an embodiment;

FIG. 2 illustrates an example of a block diagram of an electronic device according to an embodiment;

FIG. 3A illustrates an example of an electronic device projecting a screen, according to an embodiment;

FIG. 3B illustrates an example of an electronic device projecting a screen on a screen, according to an embodiment;

FIG. 3C illustrates an example of an electronic device projecting a screen, according to an embodiment;

FIG. 4 illustrates an example of an electronic device identifying an external object according to an embodiment;

FIG. 5 illustrates an example of an electronic device displaying a plurality of screens according to an embodiment;

FIG. 6 illustrates an example of an electronic device displaying a visual object having a function in a screen according to an embodiment;

FIG. 7 illustrates an example of an electronic device displaying a visual object having a function in a screen according to an embodiment;

FIG. 8 illustrates an example of an electronic device identifying an external object according to an embodiment;

FIG. 9 illustrates an example of a flowchart of an operation of an electronic device according to an embodiment;

FIG. 10 illustrates an example of a flowchart of an operation of an electronic device according to an embodiment; and

FIG. 11 is an example diagram of a network environment associated with a metaverse service.

### DETAILED DESCRIPTION

Hereinafter, one or more embodiments of the present disclosure will be described with reference to the accompanying drawings.

The one or more embodiments of the present disclosure and terms used herein are not intended to limit the technology described in the present disclosure to specific embodiments. The one or more embodiments of the present disclosure and terms used herein include various modifications, equivalents, or substitutes of the corresponding embodiment. In relation to the description of the drawings, a reference numeral may be used for a similar component. A singular expression may include a plural expression unless it is clearly meant differently in the context. In the present disclosure, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present disclosure may include a unit configured with hardware, software, or firmware, and may be used interchangeably with terms such as logic, logic block, component, or circuit, and the like. The module may be an integrally configured component or a minimum unit (or part of the integrally configured component) that performs one or more functions. For example, a module may be configured with an application-specific integrated circuit (ASIC).

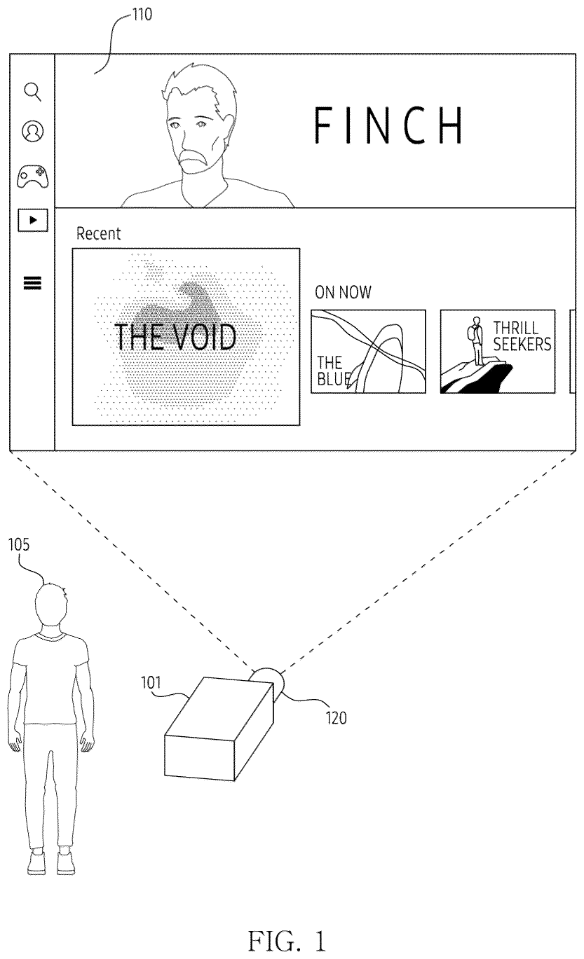

FIG. 1 illustrates an example of an electronic device projecting a screen according to an embodiment.

Referring to FIG. 1, according to an embodiment, an electronic device 101 may include an electronic device to project light such as a beam projector. For example, the beam projector may include a liquid crystal display (LCD) projector, a cathode-ray tube (CRT) projector, a digital light processing (DLP) projector, and/or a light emitting diode (LED) projector. The electronic device 101 may output the light representing a screen formed by pixels arranged two-dimensionally. The light outputted from the electronic device 101 may be reflected by an object such as a plane. A user may see the screen based on the light reflected by the object. The electronic device 101 may project the screen obtained from an interface. The interface may include a hardware interface and/or a software interface. For example, the hardware interface may include a component to establish a communication link with an external electronic device (e.g., a personal computer (PC) such as a laptop and a desktop, and a smart accessory such as a smartphone, a smart pad, a tablet PC, and a smartwatch). For example, the software interface may include a software application and/or a program that may be executed by the electronic device 101.

According to an embodiment, the electronic device 101 may project a screen 110 obtained through an interface, by controlling a projection assembly 120. For example, the projection assembly 120 may include a combination of a light source (e.g., a lamp) to emit light, optical filters to divide the light into light paths corresponding to each of three primary colors, LCD panels positioned in each of the light paths, and a prism and/or a lens to synthesize light outputted from the LCD panels. For example, the projection assembly 120 may include a combination of the light source to emit light, an optical filter selecting any one of the three primary colors from the light, a digital mirror device (DMD) to adjust reflection on a primary color filtered by the optical filter, and a lens to expand light reflected by the DMD. For example, the electronic device 101 may control the projection assembly 120 based on information (or data) obtained from an interface. The electronic device 101 may project the screen 110 by controlling the projection assembly 120. The screen 110 may include a screen associated with the information obtained from the interface. A visual object requiring (or receiving) an input of the user may be included in the screen 110.

According to an embodiment, the electronic device 101 may project the screen 110, by controlling the projection assembly 120. The electronic device 101 may identify an external object 105 (e.g., a user) based on a media content associated with the projected screen 110. The electronic device 101 may identify the external object 105, by using a camera and/or a sensor. For example, the sensor may be referred to as a time of flight (ToF) sensor. For example, the electronic device 101 may identify a distance between the electronic device 101 and the external object 105, by using the camera and/or the sensor. For example, the electronic device 101 may identify a distance between the external object 105 and the screen 110, by using the camera and/or the sensor. The electronic device 1010 may adjust a size of the screen 110 based on the (identified) distance between the external object 105 and the screen 110. For example, the electronic device 101 may identify an input to the screen 110 based on identifying a motion (or a gesture) of the external object 105, by using the camera and/or the sensor. The electronic device 101 may perform a function corresponding to the input based on identifying the input.

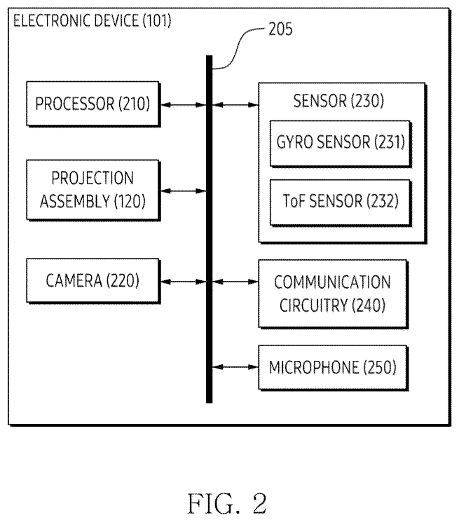

Operations of the electronic device 101, which includes an operation of adjusting a timing activating the camera and an operation of adjusting the size of the screen 110, will be described with respect to FIGS. 2 to 8.

FIG. 2 illustrates an example of a block diagram of an electronic device according to an embodiment. An electronic device 101 of FIG. 2 may include the electronic device 101 of FIG. 1.

Referring to FIG. 2, according to an embodiment, the electronic device 101 may include at least one of a processor 210, a projection assembly 120, a camera 220, a sensor 230, communication circuitry 240, or a microphone 250. The processor 210, the projection assembly 120, the camera 220, the sensor 230, the communication circuitry 240, and the microphone 250 may be electronically and/or operably coupled with each other by an electronic component such as a communication bus 205. Hereinafter, hardware being operably coupled may mean that a direct or indirect connection between the hardware is established by wire or wirelessly so that second hardware among the hardware is controlled by first hardware. Although illustrated in different blocks, an embodiment is not limited thereto. A portion (e.g., at least a portion of the processor 210, the camera 220, and the communication circuitry 240) of the hardware of FIG. 2 may be included in a single integrated circuit such as a system on a chip (SoC). A type and/or the number of the hardware included in the electronic device 101 is not limited as illustrated in FIG. 2. For example, the electronic device 101 may include only a portion of the hardware illustrated in FIG. 2.

According to an embodiment, the electronic device 101 may include hardware to process data based on one or more instructions. For example, the hardware to process the data based on the one or more instructions may include the processor 210. For example, the hardware to process the data an may include an arithmetic and logic unit (ALU), a floating point unit (FPU), a field programmable gate array (FPGA), a central processing unit (CPU), and/or an application processor (AP). The processor 210 may have a structure of a single-core processor, or a structure of a multi-core processor such as a dual core, a quad core, a hexa core, and an octa core.

According to an embodiment, the projection assembly 120 of the electronic device 101 may include a plurality of hardware assembled to emit light representing pixels arranged two-dimensionally. For example, the projection assembly 120 may include cathode-ray tubes (CRTs) to emit light of each of three primary colors in a color space and a combination of lenses to expand the light emitted from each of the CRTs. For example, the projection assembly 120 may include a combination of a light source (e.g., a lamp) to emit light, optical filters to divide the light into light paths corresponding to each of the three primary colors, liquid crystal display (LCD) panels positioned in each of the light paths, and a prism and/or a lens to synthesize light outputted from the LCD panels. For example, the projection assembly 120 may include a combination of the light source to emit light, an optical filter selecting any one of the three primary colors from the light, a digital mirror device (DMD) to adjust reflection on a primary color filtered by the optical filter, and a lens to expand the light reflected by the DMD. In terms of requiring projection of light for a display of a screen, at least one of the example combinations may be referred to as the projection assembly 120. For example, the projection assembly 120 may include a short-focus lens. The projection assembly 120 including the single-focus lens may project a screen having a size smaller than a preset size (e.g., approximately 255 centimeters), by project light at a preset distance (e.g., approximately 30 centimeters (cm)). In an embodiment, the electronic device 101 including the projection assembly 120 may be referred to as a beam projector.

According to an embodiment, the camera 220 of the electronic device 101 may include a lens assembly or an image sensor. The lens assembly may collect light emitted from a subject (e.g., the screen 110 of FIG. 1) which is a target of image capturing. The lens assembly may include one or more lenses. According to an embodiment, the camera 220 may include a plurality of lens assemblies. For example, in the camera 220, a portion of the plurality of lens assemblies may have the same lens attribute (e.g., an angle of view, a focal length, an autofocus, a f number, or an optical zoom), or at least one lens assembly may have one or more lens attributes different from lens attributes of other lens assemblies. The lens assembly may include a wide-angle lens, a telephoto lens, or a fisheye lens. For example, the electronic device 101 may identify an external object, by using the camera 220 including the fisheye lens. For example, the fisheye lens may include a super wide angle lens having an angle of view greater than or equal to approximately 180 degrees or more. According to an embodiment, the image sensor may include, for example, one image sensor selected from among image sensors with different attributes, such as an RGB sensor, a black-and-white (BW) sensor, an IR sensor, or a UV sensor, a plurality of image sensors having the same attribute, or a plurality of image sensors having different attributes. For example, each image sensor included in the image sensor may be implemented, by using a ‘charged coupled device’ (CCD) sensor or a ‘complementary metal oxide semiconductor’ (CMOS) sensor. For example, the electronic device 101 may identify the external object, by using the camera 220. The electronic device 101 may control an active state of the camera 220 based on a direction of the projection assembly 120. For example, the electronic device 101 may activate the camera 220, in a state of requiring (or receiving) an identification of a contact point on one surface at a displaying area formed by the projection assembly 120. The electronic device 101 may control the active state of the camera 220 based on the direction of the projection assembly 120 and/or a screen projected by the projection assembly 120.

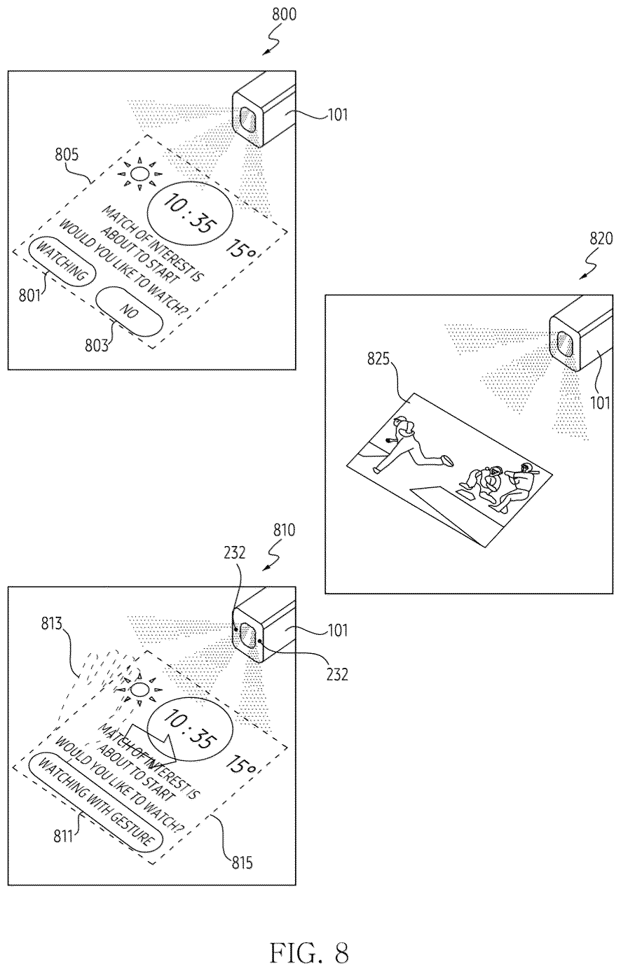

According to an embodiment, the sensor 230 of the electronic device 101 may include a gyro sensor 231. The sensor 230 of the electronic device 101 may include a depth sensor such as a ToF sensor 232. For example, the gyro sensor 231 of the electronic device 101 may obtain an electrical signal associated with rotational speed (e.g., angular speed of the electronic device 101 for preset axes) of the electronic device 101. The electronic device 101 may identify a motion of the electronic device 101 based on the electrical signal obtained through the gyro sensor 231. For example, the electronic device 101 may identify the direction of the projection assembly 120 using the gyro sensor 231. For example, the electronic device 101 may control the active state of the camera 220 based on identifying the direction of the projection assembly 120, by using the gyro sensor 231. For example, the electronic device 101 may identify an angle between the projection assembly 120 and a preset axis based on the gyro sensor 231. For example, the electronic device 101 may control a state of the camera 220 to be different from the active state based on identifying the angle greater than a threshold. For example, the electronic device 101 may control a state of the camera 220 to be active based on identifying the angle less than or equal to a threshold. The electronic device 101 may identify the external object based on the camera 220 controlled in the active state, by using the gyro sensor 231. The electronic device 101 may detect the external object, by using the ToF sensor 232 based on the camera 220 controlled in a state different from the active state, by using the gyro sensor 231. For example, the electronic device 101 may identify an external object whose a distance spaced apart from the electronic device 101 is shorter than a preset distance. For example, the electronic device 101 may include a plurality of ToF sensors 232. The electronic device 101 may identify a motion of the external object based on the plurality of ToF sensors. For example, the motion of the external object may include a motion to select a visual object displayed in a screen projected by the electronic device 101. For example, the electronic device 101 may perform a function corresponding to the motion based on identifying the motion of the external object. For example, the function corresponding to the motion may include a function associated with a gesture guided in a screen. For example, the gesture guided in the screen may include a gesture to execute a preset function. An operation of performing the function by identifying the external object by the ToF sensor 232 will be described later in FIG. 8.

According to an embodiment, the communication circuitry 240 of the electronic device 101 may include a hardware component to support transmission and/or reception of an electrical signal between the electronic device 101 and an external electronic device (e.g., a server). For example, the communication circuitry 240 may include at least one of a modem, an antenna, and an optic/electronic (O/E) converter. The communication circuitry 240 may support the transmission and/or the reception of the electrical signal based on various types of protocols such as Ethernet, a local area network (LAN), a wide area network (WAN), wireless fidelity (WiFi), Bluetooth, Bluetooth low energy (BLE), Zigbee, long term evolution (LTE), and 5th generation NR radio (5G NR). The communication circuitry 240 may be referred to as an interface. For example, the electronic device 101 may establish a communication link with a controller and/or the external electronic device through the communication circuitry 240. For example, the electronic device 101 may receive a control signal to control a screen from the controller through the communication circuitry 240. The electronic device 101 may control a screen based on receiving the control signal. For example, controlling the screen may include adjusting a size of the screen. For example, controlling the screen may include an operation of changing the screen based on an input to select a visual object displayed in the screen.

According to an embodiment, the microphone 250 of the electronic device 101 may output an electrical signal indicating vibration of atmosphere. The microphone 250 may obtain an acoustic signal. According to an embodiment, the microphone 250 included in the electronic device 101 of FIG. 2 is illustrated as singular, but may be plural. For example, the electrical signal outputted from the microphone 250 may be transmitted to the processor 210. The processor 210 may obtain, from the electrical signal, an audio signal to reconstruct the vibration, by using a speaker. For example, the processor 210 may obtain an audio signal based on sampling the acoustic signal obtained through the microphone 250. For example, the electronic device 101 may obtain a user's voice, by using the microphone 250. The electronic device 101 may perform a function indicated by the user's voice based on obtaining the user's voice.

According to an embodiment, the electronic device 101 may control the projection assembly 120. The electronic device 101 may project, by controlling the projection assembly 120, a screen obtained through an interface. For example, the interface may include a hardware interface and/or a software interface. For example, the electronic device 101 may identify the first state in which the screen requiring (or receiving) the identification of the contact point on one surface at which the displaying area by the projection assembly 120 is formed is projected. The first state may be identified by the electronic device 101 based on a layout of a screen 110. For example, the first state may include a visual object for which an input is requested in the layout of the screen 110. For example, the first state may be identified by the electronic device 101 based on information included in the screen 110 obtained through the interface. For example, the first state may be identified by the electronic device 101 based on instructions included in a software application to project the screen 110. The electronic device 101 may activate, in the first state, the camera 220 positioned toward a second direction different from a first direction of the projection assembly 120. However, a location of the camera 220 is not limited. According to an embodiment, the electronic device 101 may identify a second state different from the first state in which the screen 110 requiring the identification of the contact point is projected. For example, the second state may include a state in which a screen outputting a ‘media content, such as a movie, is projected.

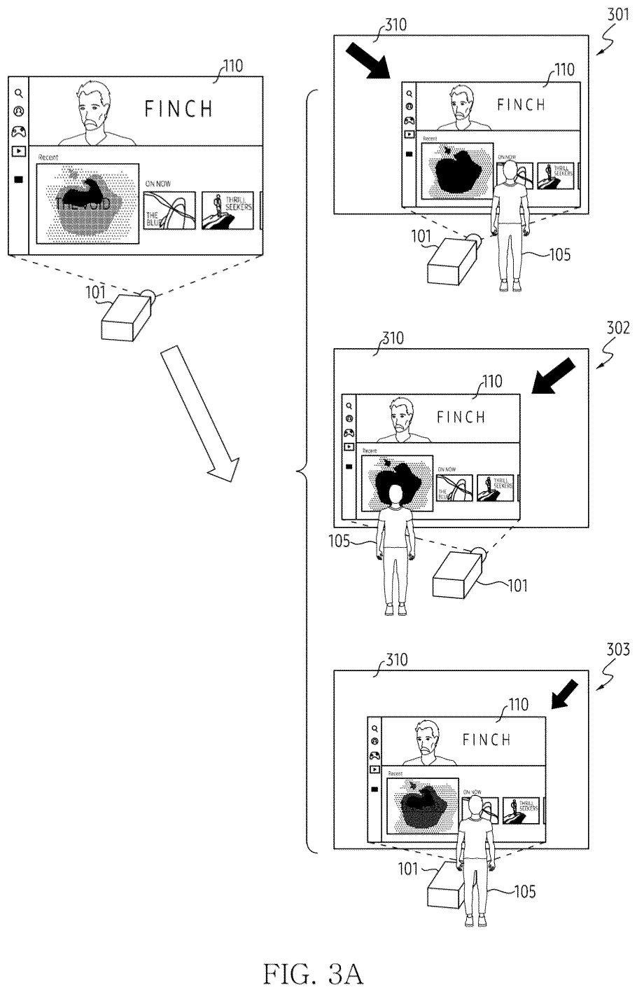

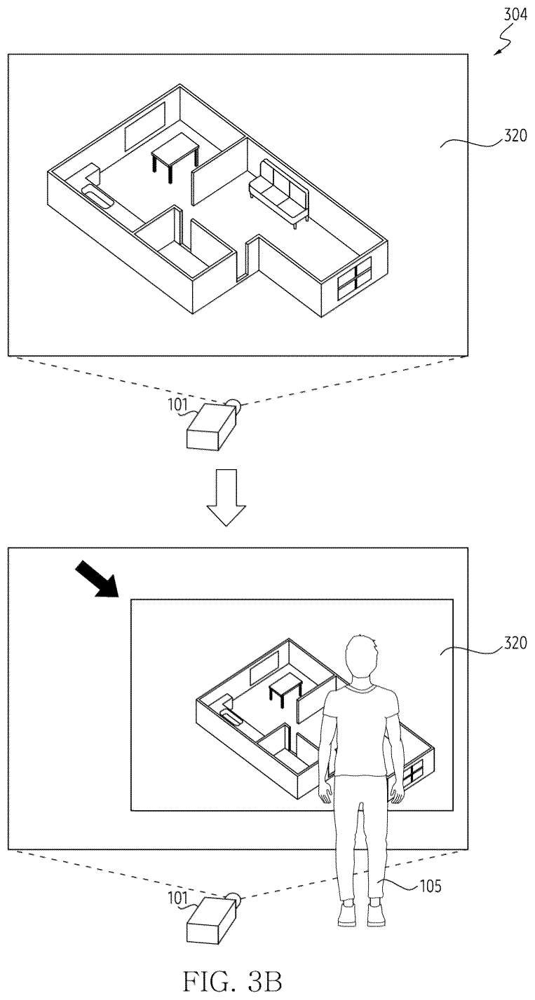

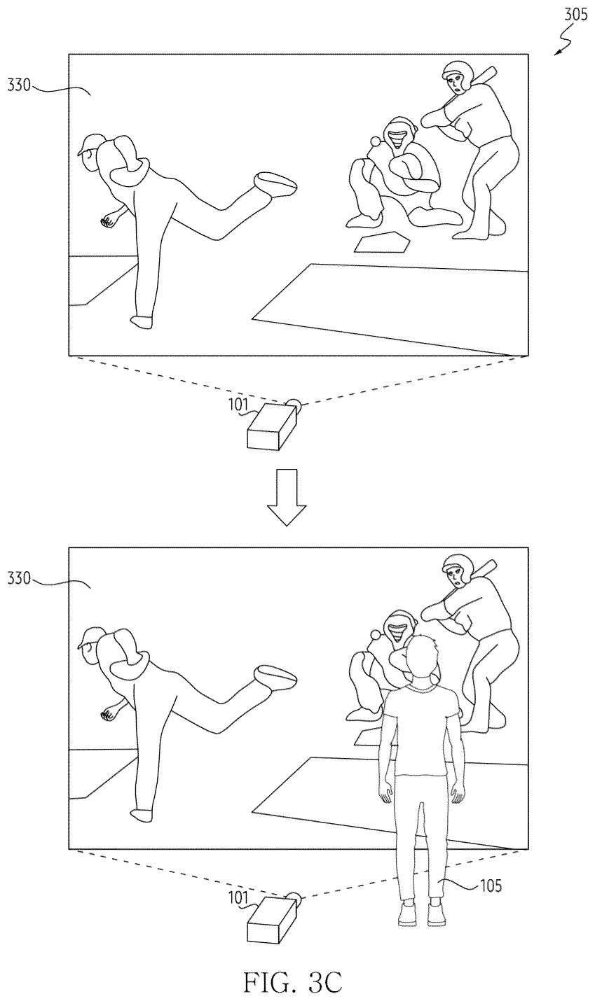

According to an embodiment, the electronic device 101 may identify an external object from information, by using the activated camera 220. For example, the information obtained using the activated camera 220 may include one of a plurality of images obtained by the camera 220. The electronic device 101 may identify an external object included in the images. For example, the external object may include a person corresponding to the user. The electronic device 101 may adjust the size of the screen projected by the projection assembly 120 based on identifying the external object. For example, the electronic device 101 may adjust the size of the screen based on a location of the external object. For example, the electronic device 101 may identify that the external object is within a preset distance from one surface on which the screen is projected. The electronic device 101 may reduce the size of the screen based on identifying the external object less than or equal to the preset distance from the surface on which the screen is projected. For example, the electronic device 101 may identify that the external object is outside the preset distance from the surface on which the screen is projected. The electronic device 101 may maintain or enlarge the size of the screen based on identifying the external object greater than the preset distance from the surface on which the screen is projected. An operation of adjusting the size of the screen based on the location of the external object will be described later with reference to FIGS. 3A to 3C.

According to an embodiment, the electronic device 101 may identify an external object while projecting the screen, by using the projection assembly 120. The electronic device 101 may identify at least a portion of a body part of the external object. The electronic device 101 may identify an eye that is at least a portion of the body part. The electronic device 101 may identify a location of the eye. The electronic device 101 may project a screen corresponding to the location of the eye. For example, human eyes may clearly observe and judge objects in a field-ofview (FoV) of approximately 30 degrees in a horizontal direction and approximately 55 degrees in a vertical direction. The electronic device 101 may project the screen in the field-of-view based on identifying at least a portion of the body part of the external object.

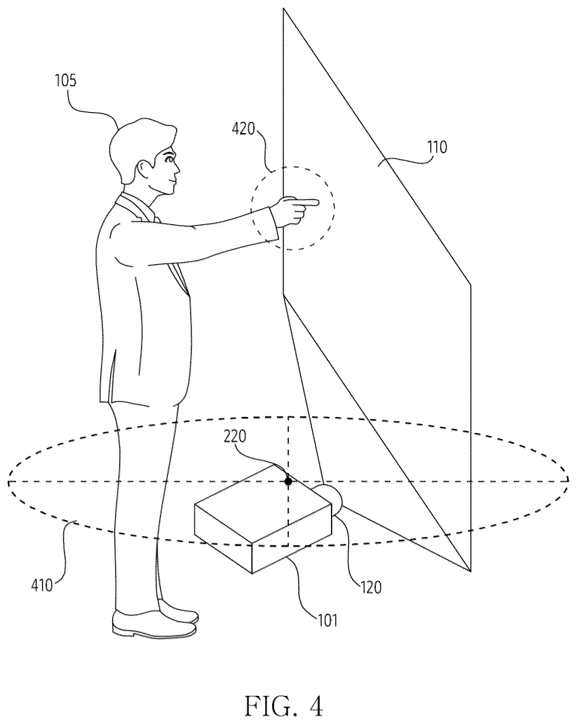

The electronic device 101 according to an embodiment may identify an input of the external object to the screen projected by the projection assembly 120 based on the camera 220. For example, the input of the external object to the screen may be matched to the identification of the contact point. For example, the electronic device 101 may identify the contact point, by using the camera 220. By using the camera 220, the electronic device 101 may identify a distance between a part (e.g., a human finger) of the external object and the surface on which the screen by the projection assembly 120 is projected. The electronic device 101 may identify the contact point based on identifying the distance between the external object and the surface on which the screen by the projection assembly 120 is projected, which is shorter than the preset distance. The electronic device 101 may identify an input to a point at which the contact point is identified based on identifying the contact point. An operation of identifying the contact point will be described later in FIG. 4.

According to an embodiment, the electronic device 101 may identify a motion of the external object while projecting the screen. For example, the electronic device 101 may identify the motion of the external object through the camera 220 while projecting the screen. The electronic device 101 may identify the motion of the external object, which is a preset motion. For example, the electronic device 101 may perform a function corresponding to the preset motion based on identifying that the motion of the external object is the preset motion. For example, the electronic device 101 may execute a second software application different from a first software application to project a first screen based on identifying a first preset motion. The electronic device 101 may project the first screen and a second screen associated with the second software application based on executing the second software application. The electronic device 101 may divide the displaying area. For example, the electronic device 101 may divide the displaying area into a first partial area and a second partial area. The electronic device 101 may project the first screen in the first partial area and project the second screen in the second partial area. For example, the electronic device 101 may project a plurality of screens based on dividing the displaying area.

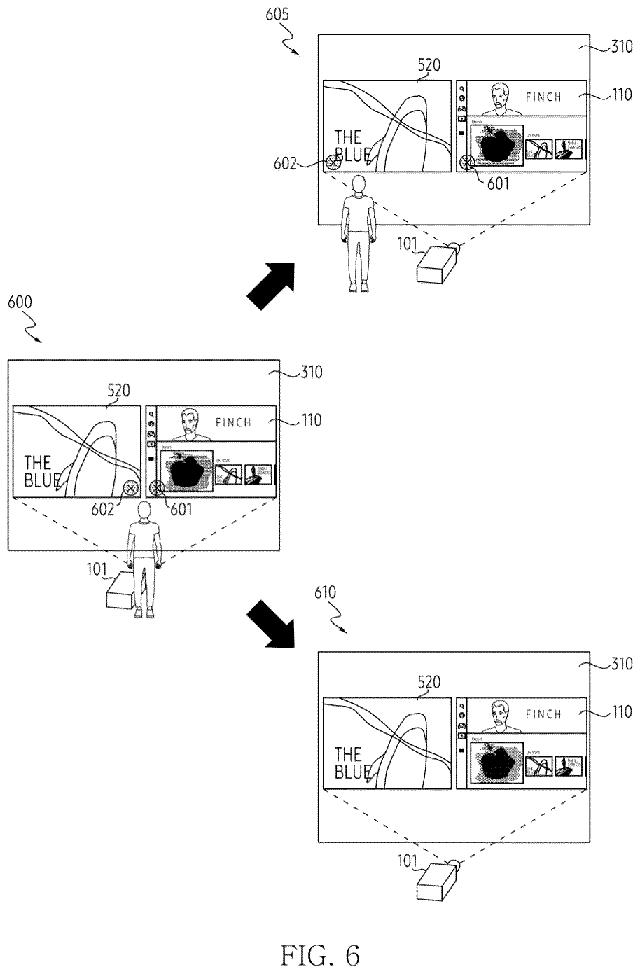

According to an embodiment, the electronic device 101 may project a plurality of screens. For example, the electronic device 101 may project the first screen associated with the first software application and the second screen associated with the second software application. The electronic device 101 may identify an external object in a state of projecting the first screen and the second screen. The electronic device 101 may identify a distance between the external object and the displaying area (or one surface on which a screen is projected) in the state projecting the first screen and the second screen. The electronic device 101 may identify the distance shorter than a preset threshold in the state projecting the first screen and the second screen. The electronic device 101 may project a visual object (e.g., an end button) to terminate each of the first software application and the second software application based on identifying the distance shorter than the preset threshold. The electronic device 101 may project the visual object on both of the first screen and the second screen. An operation of displaying the visual object will be described later in FIG. 6.

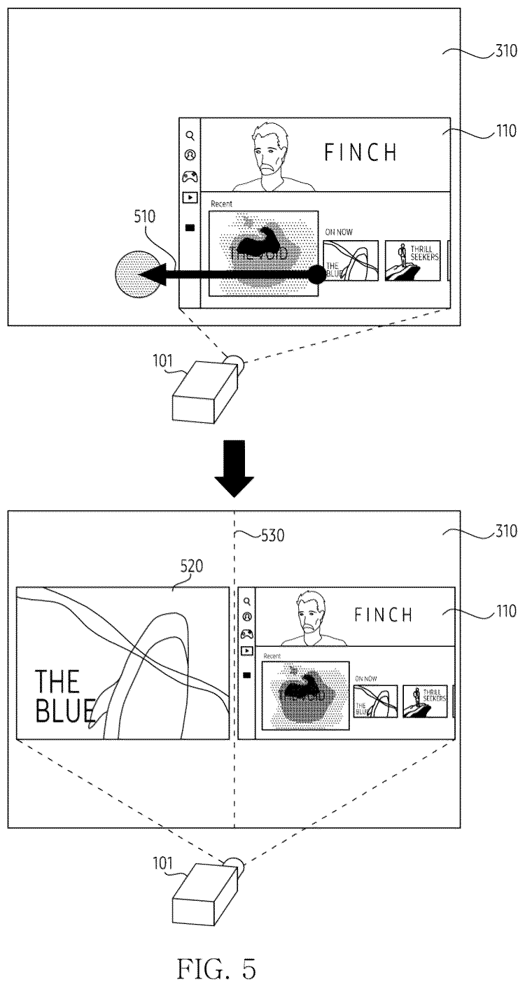

According to an embodiment, the electronic device 101 may identify that a distance between the external object and the displaying area is longer than or equal to the preset threshold. For example, the electronic device 101 may cease to, based on identifying the distance longer than or equal to the preset threshold, project the visual object. According to an embodiment, the electronic device 101 may project a border line to divide the first screen and the second screen while projecting the first screen and the second screen. The electronic device 101 may identify the border line formed between the first screen and the second screen. The electronic device 101 may adjust a size of the first screen and the second screen based on the border line formed between the first screen and the second screen. An operation of adjusting the size of the screens will be described later in FIG. 5.

As described above, according to an embodiment, the electronic device 101 may identify the state in which the screen requiring the identification of the contact point on the surface in which the displaying area is formed by the projection assembly 120 is projected. The electronic device 101 may activate the camera 220 in the state. The electronic device 101 may deactivate the camera 220 in the second state different from the state, which is the first state. For example, in the second state, the electronic device 101 may maintain a size of the screen 110. According to an embodiment, the electronic device 101 may identify an external object from the information obtained, by using the activated camera 220. In response to (or based on) identifying the external object, the electronic device 101 may change the size of the screen based on a location of the external object. The electronic device 101 may control activation of the camera 220 based on the first state and the second state. The electronic device 101 may reduce power consumption by controlling the activation of the camera 220 based on the state. The electronic device 101 may enhance a user experience of the electronic device 101 by adjusting the size of the screen based on the location of the external object.

FIG. 3A illustrates an example of an electronic device projecting a screen according to an embodiment. FIG. 3B illustrates an example of an electronic device projecting a screen according to an embodiment. FIG. 3C illustrates an example of an electronic device projecting a screen according to an embodiment. An electronic device 101 of FIGS. 3A to 3C may include the electronic device 101 of FIG. 1 and/or FIG. 2. Operations of FIGS. 3A to 3C may be performed by the processor 210 of FIG. 2.

According to an embodiment, the electronic device 101 may control a projection assembly 120. According to an embodiment, the electronic device 101 may project, by controlling the projection assembly 120, a screen 110 obtained through an interface. For example, the interface may include a hardware interface and/or a software interface. The electronic device 101 may project the screen 110 requiring identification of a contact point on one surface at a displaying area formed by the projection assembly 120. The electronic device 101 may identify the screen 110 requiring the identification of the contact point based on a layout of the screen 110. The electronic device 101 may identify the screen 110 requiring the identification of the contact point based on information included in the screen 110 obtained through the interface. For example, the electronic device 101 may identify that the screen 110 includes information requiring an input from an external object (or a user). For example, the electronic device 101 may include a screen to identify a gesture (e.g., an air gesture) of the user while projecting the screen 110.

According to an embodiment, the electronic device 101 may identify an external object 105 while projecting the screen 110. For example, the external object 105 may include the user. The electronic device 101 may identify the external object 105, by using a camera (e.g., the camera 220 of FIG. 2). The electronic device 101 may identify a location of the external object 105 based on identifying the external object 105. A first example 301, a second example 302, and/or a third example 303 of FIG. 3A may illustrate that the location of the external object 105 is different. For example, in the first example 301, the external object 105 may be located in a right area of one surface on which the screen 110 is projected. For example, in the second example 302, the external object 105 may be located in a left area of the surface on which the screen 110 is projected. For example, in the third example 303, the external object 105 may be located in a central area of the surface on which the screen 110 is projected. The electronic device 101 may identify the location of the external object 105 with respect to the screen 110 using the camera while projecting the screen 110.

According to an embodiment, in the first example 301, the electronic device 101 may identify the external object 105 while projecting the screen 110. For example, the electronic device 101 may identify the location of the external object 105 with respect to one surface 310 at which the displaying area is formed by the projection assembly 120. In the first example 301, the external object 105 may be located in a right area with respect to the surface 310. For example, the electronic device 101 may change a size of the screen 110 based on identifying the external object 105 located in the right area with respect to the surface 310. For example, the electronic device 101 may change the size of the screen 110 based on identifying the external object 105 located in the right area with respect to the surface 310. For example, the electronic device 101 may change the size of the screen 110 to correspond to the location of the external object 105. For example, the electronic device 101 may change the size of the screen 110 by adjusting a left periphery and an upper periphery of the screen 110.

In the second example 302, according to an embodiment, the electronic device 101 may identify the external object 105 while projecting the screen 110. For example, the electronic device 101 may identify the location of the external object 105 with respect to the surface 310 at which the displaying area is formed by the projection assembly 120. In the second example 302, the external object 105 may be located in a left area with respect to the surface 310. For example, the electronic device 101 may change the size of the screen 110 based on identifying the external object 105 located in the left area with respect to the surface 310. For example, the electronic device 101 may change the size of the screen 110 to correspond to the location of the external object 105 based on identifying the external object 105 located in the left area with respect to the surface 310. For example, the electronic device 101 may change the size of the screen 110 by adjusting a right periphery and the upper periphery of the screen 110.

In the third example 303, according to an embodiment, the electronic device 101 may identify the external object 105 while projecting the screen 110. For example, the electronic device 101 may identify the location of the external object 105 with respect to the surface 310 at which the displaying area is formed by the projection assembly 120. In the third example 303, the external object 105 may be located in a central area with respect to the surface 310. For example, the electronic device 101 may change the size of the screen 110 based on identifying the external object 105 located in the central area with respect to the surface 310. For example, the electronic device 101 may change the size of the screen 110 to correspond to the location of the external object 105 based on identifying the external object 105 located in the central area with respect to the surface 310. For example, the electronic device 101 may move peripheries of the screen 110 based on one point included in the central area of the screen. The electronic device 101 may adjust the size of the screen 110 by moving the peripheries of the screen 110.

According to an embodiment, the electronic device 101 may change the size of the screen 110 to correspond to a field-of-view of the external object 105. For example, the electronic device 101 may identify at least a portion of a body part of the external object 105. For example, the electronic device 101 may identify an eye which is at least a portion of the body part of the external object 105. The electronic device 101 may identify a location of the eye. The electronic device 101 may identify the field-of-view of the external object 105 based on identifying the location of the eye of the external object 105. The electronic device 101 may adjust a location and/or the size of the screen 110 based on predicting the field-of-view of the external object 105. The electronic device 101 may perform an operation to project the screen 110 in the field-of-view of the external object 105.

Referring to FIG. 3B, in a fourth example 304, according to an embodiment, the electronic device 101 may project a screen 320 associated with a media content. For example, the media content may include geographic information. For example, the media content may need to be edited. The screen 320 associated with the media content may include the screen 320 to edit the media content. The electronic device 101 may identify the external object 105 in a state of projecting the screen 320 associated with the media content. The electronic device 101 may change a size of the screen 320 based on identifying the location of the external object 105. An operation of changing the size of the screen 320 may be referred to as the operations of FIG. 3A. For example, the electronic device 101 may change the size of the screen 320 based on identifying a distance between one surface on which the screen 320 is projected and the external object 105. The electronic device 101 may identify a contact point on the surface projecting the screen 320 in a state of changing the size of the screen 320. The electronic device 101 may identify an input to the screen 320 based on identifying the contact point. The electronic device 101 may perform corresponding to the input based on identifying the input. For example, the input may include an input to edit the media content. The input to edit the media content may include an input to move a visual object included in the media content or adjust a size of the visual object.

As described above, according to an embodiment, the electronic device 101 may identify the external object 105 while projecting the screen 110. The electronic device 101 may identify the location of the external object 105 based on identifying the external object 105. For example, the electronic device 101 may change the size of the screen 110 based on the location of the external object 105. For example, the electronic device 101 may change a location projecting the screen 110 based on the location of the external object 105. The electronic device 101 may project the screen 110 corresponding to an area in which the external object 105 is identified. A user corresponding to the external object 105 may cause the identification of the contact point by the electronic device 101. The electronic device 101 may enhance a user experience of the electronic device 101 by projecting the screen 110 in an area corresponding to the location of the external object 105.

Referring to FIG. 3C, in a fifth example 305, according to an embodiment, the electronic device 101 may project a screen 330 associated with to a media content. For example, the media content may include a media content such as a video. For example, the screen 330 associated with the media content may include an area to play the video. For example, the screen 330 associated with the media content may be identified based on a software application. For example, the software application may include a software application to play the video. The electronic device 101 may identify the external object 105 while projecting the screen 330 associated with the media content. The electronic device 101 may maintain a size of the screen 330 based on identifying the external object 105 while projecting the screen 330. For example, while projecting the screen 330 playing the media content such as the video, the electronic device 101 may maintain the size of the screen 330 even when identifying the external object 105. The screen 330 associated with the media content such as the video may be a single layout.

As described above, according to an embodiment, the electronic device 101 may change or maintain a size of a screen based on the screen being projected. The electronic device 101 may change or maintain the size of the screen based on a layout of the screen or a software application associated with the screen. The electronic device 101 may change or maintain the size of the screen based on a media content projected onto the screen. The electronic device 101 may enhance the user experience of the electronic device 101 by changing or maintaining the size of the screen based on the media content projected onto the screen.

FIG. 4 illustrates an example of an electronic device identifying an external object according to an embodiment. An electronic device 101 of FIG. 4 may include the electronic device 101 of FIG. 1, 2, 3A, 3B, and/or 3C. Operations of FIG. 4 may be performed by the processor 210 of FIG. 2.

Referring to FIG. 4, according to an embodiment, the electronic device 101 may control a projection assembly 120. The electronic device 101 may project, by controlling the projection assembly 120, a screen 110 obtained through an interface. The electronic device 101 may project the screen 110 requiring identification of a contact point on one surface at a displaying area formed by the projection assembly 120. The electronic device 101 may activate, in a state in which the screen 110 is projected, a camera 220 positioned toward a second direction 415 different from a first direction 405 of the projection assembly 120. For example, the electronic device 101 may identify a second state different from the state, which is a first state, in which the screen requiring the identification of the contact point is projected. The electronic device 101 may deactivate the camera 220 in the second state. For example, the activated camera 220 may identify an external object 105 in a range 410. For example, the range 410 may be formed by the camera 220 including a fisheye lens. The electronic device 101 may identify a distance between the external object 105 or a portion 420 of the external object 105 and the screen 110 (or one surface) based on identifying an external object included in the range 410. The electronic device 101 may identify the contact point based on identifying the distance. The range 410 may vary according to a direction in which the camera 220 is positioned and/or a lens included in the camera 220, but is not limited thereto.

According to an embodiment, the electronic device 101 may identify the external object 105 from information obtained using the camera 220 activated in the first state. For example, the information may include at least one of a plurality of images obtained by using the camera 220. The electronic device 101 may identify a user who is the external object 105 in at least one of the plurality of images obtained by using the camera 220. The electronic device 101 may identify a portion of the external object 105. For example, the portion of the external object 105 may include a body part of an external object corresponding to a person. For example, the portion of the external object 105 may include a human hand (or a finger). The electronic device 101 may identify a distance between the portion 420 of the external object 105 and the surface (or the screen 110). For example, the electronic device 101 may identify the distance between the portion 420 of the external object 105 and the surface, by using the camera 220. According to an embodiment, the electronic device 101 may identify an input to the screen 110 by the external object 105 based on identifying the distance shorter than a preset distance. For example, identifying the distance shorter than the preset distance may be substantially the same as identifying the contact point. The electronic device 101 may perform a function corresponding to the input based on identifying the input. For example, the function may include a function associated with a visual object displayed in the screen.

As described above, according to an embodiment, the electronic device 101 may project the screen 110 requiring identification of the contact point. For example, the screen 110 may include a screen requiring the identification of the contact point. The electronic device 101 may identify a distance between the external object 105 and the screen 110 (or the surface at which the displaying area is formed) while projecting the screen 110. The electronic device 101 may identify the distance shorter than the preset distance. The electronic device 101 may identify the contact point based on identifying the distance shorter than the preset distance. The electronic device 101 may perform a function associated with a visual object positioned at a location corresponding to the contact point based on identifying the contact point. The electronic device 101 may input by identifying the distance shorter than the preset distance. The electronic device 101 may perform a function corresponding to the input based on identifying the input. The electronic device 101 may enhance a user experience of the electronic device 101 by receiving an input from the external object 105 while projecting the screen 110.

FIG. 5 illustrates an example of an electronic device displaying a plurality of screens according to an embodiment. An electronic device 101 of FIG. 5 may include the electronic device 101 of FIGS. 1, 2, 3A, 3B, 3C, and/or 4. Operations of FIG. 5 may be performed by the processor 210 of FIG. 2.

Referring to FIG. 5, according to an embodiment, the electronic device 101 may project a screen 110 obtained through an interface, by controlling a projection assembly 120. The electronic device 101 may identify a state in which the screen 110, which requires (or receives) an identification of a contact point on one surface 310 at a displaying area formed by the projection assembly 120, is projected. The electronic device 101 may activate, in the state in which the screen 110 is projected, a camera (e.g., the camera 220 of FIG. 2) to identify an external object. The electronic device 101 may identify the external object, by using the activated camera. The electronic device 101 may change a size of the screen 110 in response to identifying the external object. In an example of FIG. 5, the size of the screen 110 is reduced.

According to an embodiment, the electronic device 101 may project the reduced screen 110. The electronic device 101 may identify an external object while projecting the screen 110. For example, the electronic device 101 may identify a motion (or a gesture) of the external object based on identifying the external object. The electronic device 101 may identify the motion of the external object corresponding to a preset motion (or a preset gesture). For example, the electronic device 101 may identify a motion moving a contact point in a direction 510 in a state in which the contact point with respect to the screen 110 is formed. For example, the electronic device 101 may project a second screen 520 different from the screen 110, which is the first screen 110, based on identifying the contact point moving in the direction 510. For example, the electronic device 101 may project the first screen 110 for representing a first software application and the second screen 520 for representing a second software application. For example, the electronic device 101 may display a visual object associated with a guide to project the second software application based on identifying the preset motion. The visual object may be represented as a visual object such as a pop-up window. The electronic device 101 may project by including a list of software applications in the visual object. The electronic device 101 may receive an input indicating to select the second software application different from the first software application associated with the screen 110 being projected in the list. For example, the input may be identified by the contact point. Although an example of projecting two screens in FIG. 5 is described, the number of screens that may be projected by the electronic device 101 is not limited.

According to an embodiment, the electronic device 101 may project the first screen 110 associated with the first software application and the second screen 520 associated with the second software application on the surface 310. The electronic device 101 may identify a border line 530 while projecting the first screen 110 and the second screen 520. According to an embodiment, the electronic device 101 may project the border line 530 to divide the first screen 110 and the second screen 520. The electronic device 101 may receive an input for the border line 530. For example, the electronic device 101 may identify the input based on identifying a contact point in a preset distance from the border line 530. The electronic device 101 may identify movement of the contact point. For example, the movement of the contact point may include movement of a contact point identified by the external object. The electronic device 101 may adjust a size of the first screen 110 and the second screen 520 based on the movement of the contact point. For example, the electronic device 101 may adjust the size of the first screen 110 and the second screen 520 in a direction corresponding to the movement of the contact point. For example, in a case that the contact point moves to left, the electronic device 101 may reduce the size of the second screen 520 and enlarge the size of the first screen 110. For example, in a case that the contact point moves to right, the electronic device 101 may reduce the size of the first screen 110 and enlarge the size of the second screen 520.

As described above, according to an embodiment, the electronic device 101 may project the plurality of screens 110 and 520 on the surface 310 at which the displaying area is formed. The number of the plurality of screens is not limited. The electronic device 101 may adjust a size of each of the plurality of screens based on a border line while projecting the plurality of screens. The electronic device 101 may adjust the size of each of the plurality of screens based on a user input (or the preset motion). The electronic device 101 may enhance a user experience of the electronic device 101 by projecting the plurality of screens having the size desired by the user.

FIG. 6 illustrates an example of an electronic device displaying a visual object having a function in a screen according to an embodiment. An electronic device 101 of FIG. 6 may include the electronic device 101 of FIGS. 1, 2, 3A, 3B, 3C, 4, and/or 5. Operations of FIG. 6 may be performed by the processor 210 of FIG. 2.

Referring to FIG. 6, according to an embodiment, the electronic device 101 may project a plurality of screens 110 and 520 on one surface 310 at a displaying area. The electronic device 101 may identify an external object 105 while projecting the plurality of screens 110 and 520. For example, the electronic device 101 may identify a location of the external object 105 while projecting the plurality of screens 110 and 520. The electronic device 101 may project the visual objects 601 and 602 based on the location of the external object 105. For example, the electronic device 101 may identify a distance between the external object 105 and the surface 310 in a state in which the first screen 110 and the second screen 520 is projected. For example, the electronic device 101 may identify the distance shorter than a preset threshold. The electronic device 101 may project visual objects 601 and 602 associated with termination of a first software application associated with the first screen 110 and a software application associated with the second screen 520 based on identifying the distance shorter than the preset threshold. For example, the electronic device 101 may project the visual objects 601 and 602 on both of the first screen 110 and the second screen 520. The electronic device 101 may project the first visual object 601 corresponding to the first screen 110 and the second visual object 602 corresponding to the second screen 520. For example, the visual objects 601 and 602 may include a visual object to terminate software applications associated with the first screen 110 and the second screen 520. For example, the electronic device 101 may project the first visual object 601 associated with termination of the first software application associated with the first screen 110. For example, the electronic device 101 may project the second visual object 602 associated with termination of the second software application associated with the second screen 520. For example, the electronic device 101 may project the visual objects 601 and 602 based on the location of the external object 105.

For example, the electronic device 101 may project the visual objects 601 and 602 adjacent to a border line (e.g., the border line 530 of FIG. 5) to divide the first screen 110 and the second screen 520 in a first example 600 in which the external object 105 is identified in a central area. For example, the electronic device 101 may project the visual objects 601, and 602 to be located on a left side of each of the screens, in a second example 605 in which the external object 150 is identified in a left area. For example, the visual objects 601 and 602 may be projected in the screens 110 and 520 corresponding to each of the visual objects 601 and 602. For example, the visual objects 601 and 602 may be projected outside the screens 110 and 520 to terminate the software applications associated with each of the screens 110 and 520 based on a separate visual object such as a pop-up window. An area to which the visual objects 601 and 602 are projected is not limited.

In a third example 610, the external object 105 is identified at a distance longer than or equal to a preset distance. According to an embodiment, the electronic device 101 may project the visual objects 601 and 602 by overlapping on the screens 110 and 520 in a state of identifying the external object 105. The electronic device 101 may project the visual objects 601 and 602 based on identifying that the distance between the external object 105 and the surface 310 is shorter than the preset threshold. The electronic device 101 may identify that the distance between the external object 105 and the surface 310 is longer than or equal to the preset threshold while projecting the visual objects 601 and 602. For example, the electronic device 101 may cease to project the visual objects 601 and 602 based on identifying that the distance between the external object 105 and the surface 310 is longer than or equal to the preset threshold.

As described above, according to an embodiment, the electronic device 101 may project the visual objects 601 and 602 associated with termination of each of the first screen 110 and the second screen 520 based on the location of the external object 105. The electronic device 101 may cease to project the visual objects 601 and 602 based on the location of the external object 105. The electronic device 101 may enhance a user experience of the electronic device 101 by projecting or ceasing to project the visual objects 601 and 602 according to the location of the external object 105.

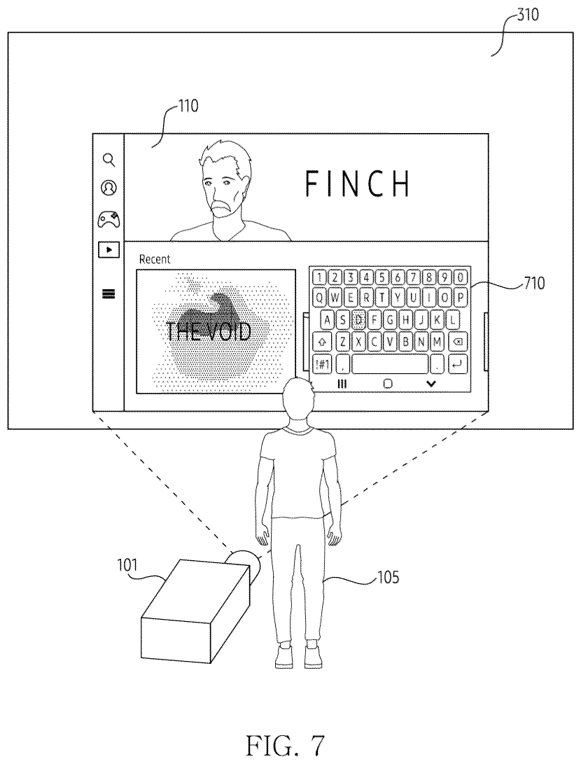

FIG. 7 illustrates an example of an electronic device displaying a visual object having a function in a screen according to an embodiment. An electronic device 101 of FIG. 7 may include the electronic device 101 of FIGS. 1, 2, 3A, 3B, 3C, 4, 5, and/or 6. Operations of FIG. 7 may be performed by the processor 210 of FIG. 2.

Referring to FIG. 7, according to an embodiment, the electronic device 101 may project a screen 110 requiring identification of a contact point on one surface at a displaying area formed by a projection assembly 120. The electronic device 101 may activate, in a state in which the screen 110 requiring the identification of the contact point is projected, a camera (e.g., the camera 220 of FIG. 2). According to an embodiment, the electronic device 101 may identify an external object 105 using the activated camera in the state projecting the screen 110. The electronic device 101 may identify a location of the external object 105 with respect to the surface 310 on which the screen 110 is projected. The electronic device 101 may change a size of the screen 110 based on identifying the location of the external object 105. In an example of FIG. 7, the size of the screen 110 is reduced based on identifying the external object 105.

According to an embodiment, the electronic device 101 may project a visual object 710 to input text in the screen 110. For example, the electronic device 101 may identify a visual object 720 to receive text, such as a text field, in the screen 110. The electronic device 101 may identify an input to the visual object 720 to receive a text message. For example, the input may include identifying a contact point corresponding to the visual object 720. The electronic device 101 may project the visual object 710 to input the text based on identifying the input to the visual object 720. For example, the visual object 710 to input the text may be referred to as a virtual keyboard. For example, the electronic device 101 may project the text corresponding to the input in the visual object 720, such as the text field, based on the input to the visual object 710.

According to an embodiment, the electronic device 101 may project the visual object 710 to the input the text message based on the location of the external object 105. For example, the electronic device 101 may project the visual object 710 based on the location of the external object 105 with respect to the surface 310 on which the screen 110 is projected. For example, the electronic device 101 may project the visual object 710 in a left area of the surface 310 based on identifying the external object 105 located in the left area with respect to the surface 310. For example, the electronic device 101 may project the visual object 710 in a right area of the surface 310 based on identifying the external object 105 located in the right area with respect to the surface 310. For example, the electronic device 101 may project the visual object 710 in a central area of the surface 310 based on identifying the external object 105 located in the central area with respect to the surface 310.

As described above, according to an embodiment, the electronic device 101 may project the screen 110 requiring the identification of the contact point. The electronic device 101 may identify the external object 105 by activating the camera in the state in which the screen 110 requiring the identification of the contact point is projected. The electronic device 101 may identify the visual object 720 to receive the text such as the text field in the screen 110. The electronic device 101 may identify the input to the visual object 720. The electronic device 101 may project the visual object 710 to input the text based on identifying the input. The electronic device 101 may project the visual object 710 based on the location of the external object 105. For example, the electronic device 101 may project the visual object 710 in an area corresponding to the location of the external object 105. The electronic device 101 may enhance a user experience of the electronic device 101 by projecting the visual object 710 in the area corresponding to the location of the external object 105.

FIG. 8 illustrates an example of an electronic device identifying an external object according to an embodiment. An electronic device 101 of FIG. 8 may include the electronic device 101 of FIGS. 1, 2, 3A, 3B, 3C, 4, 5, 6, and/or 7. Operations of FIG. 8 may be performed by the processor 210 of FIG. 2.

Referring to FIG. 8, according to an embodiment, the electronic device 101 may identify a direction in which screens 805 and 815 are projected based on a sensor (e.g., the sensor 230 of FIG. 2). For example, the electronic device 101 may identify the direction in which the screens 805 and 815 are projected based on a gyro sensor (e.g., the gyro sensor 241 of FIG. 2). In a first example 800 and a second example 810 of FIG. 8, the screens 805 and 815 are projected in a direction less than or equal to a preset angle with respect to the ground. The examples 800 and 810 may be associated with a second state different from a first state in which the screens 805 and 815, which requires (or receives) an identification of a contact point on one surface at a displaying area, is projected.

Referring to the first example 800, according to an embodiment, the electronic device 101 may deactivate a camera (e.g., the camera 220 of FIG. 2) in the second state. The electronic device 101 may project the screen 805 in the second state. The electronic device 101 may identify visual objects 801 and 803 included in the screen 805. The electronic device 101 may identify an input to the visual objects 801 and 803. For example, the electronic device 101 may identify the input based on information (or data) obtained from a ToF sensor (e.g., the ToF sensor 232 of FIG. 2). For example, the electronic device 101 may identify an input indicating to select the visual object 801. The electronic device 101 may perform an operation corresponding to the input based on identifying the input. For example, the electronic device 101 may project a screen 825 such as a third example 820 based on identifying the input. According to an embodiment, the electronic device 101 may identify an input indicating to select the visual object 803. The electronic device 101 may perform an operation corresponding to the input based on identifying the input indicating to select the visual object 803. For example, the electronic device 101 may maintain an operation of projecting a portion of the screen 805 based on the input indicating to select the visual object 803.

According to an embodiment, the electronic device 101 may activate a microphone (e.g., the microphone 250 of FIG. 2) in the second state projecting the screen 805 such as the first example 800. The electronic device 101 may identify a voice signal, by using the activated microphone. For example, the electronic device 101 may identify a first voice signal corresponding to the visual object 801. For example, the first voice signal may include a voice signal corresponding to ‘watching’, which is text included in the visual object 801. The electronic device 101 may perform an operation corresponding to the visual object 801 based on identifying the first voice signal. The electronic device 101 may project the screen 825 such as the third example 820 based on identifying the first voice signal. According to an embodiment, the electronic device 101 may identify a second voice signal corresponding to the visual object 803. The electronic device 101 may identify the second voice signal corresponding to ‘No’, which is text included in the visual object 803. The electronic device 101 may perform an operation corresponding to the visual object 803 based on identifying the second voice signal. For example, the electronic device 101 may maintain an operation of projecting a portion of the screen 805 based on identifying the second voice signal.

Referring to the second example 810, according to an embodiment, the electronic device 101 may identify the second state different from the first state in which a screen requiring the identification of the contact point is projected. The electronic device 101 may project the screen 815 in the second state. For example, the electronic device 101 may project a visual object 811 to guide a gesture of a user. The electronic device 101 may identify an external object 813 while projecting the visual object 811 in the screen 815. For example, the electronic device 101 may identify the external object 813 based on the ToF sensor. The external object 813 may include a body part such as a hand of the user. However, it is not limited thereto. The electronic device 101 may identify the gesture corresponding to the visual object 811. For example, the electronic device 101 may perform an operation corresponding to text projected in the screen 815 based on identifying the gesture. For example, the electronic device 101 may project the screen 825 such as the third example 820 based on identifying the visual object 811.

As described above, according to an embodiment, the electronic device 101 may identify the second state different from the first state in which the screen requiring the identification of the contact point on the surface at which the displaying area is formed is projected. The electronic device 101 may perform an operation based on the microphone or the sensor while projecting the screens 805 and 815 in the second state. For example, the electronic device 101 may identify the input to the visual objects 801, 803, and 811, by using the microphone or the sensor. The electronic device 101 may perform the input to the visual objects 801, 803, and 811 based on identifying the input. The electronic device 101 may perform an operation, by using a component different from the camera deactivated in the second state. The electronic device 101 may reduce power consumed by the camera by deactivating the camera in the second state. The electronic device 101 may enhance a user experience of the electronic device 101 by performing the operation using the component.

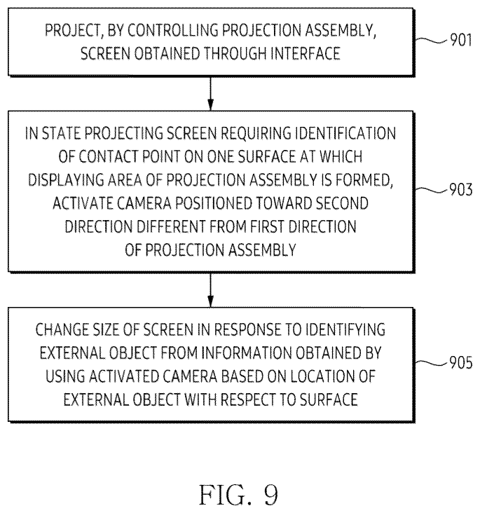

FIG. 9 illustrates an example of a flowchart of an operation of an electronic device according to an embodiment. The electronic device of FIG. 9 may include the electronic device 101 of FIGS. 1, 2, 3A, 3B, 3C, 4, 5, 6, 7, and/or 8. Operations of FIG. 9 may be performed by the processor 210 of FIG. 8.

Referring to FIG. 9, in an operation 901, according to an embodiment, the electronic device may control a projection assembly (e.g., the projection assembly 120 of FIG. 2). The electronic device may project, by controlling the projection assembly, a screen (e.g., the screen 110 of FIGS. 1 to 7 and/or the screens 805, 815, and 825 of FIG. 8) obtained through an interface. For example, the interface may include a software interface and/or a hardware interface.

In an operation 903, according to an embodiment, the electronic device may identify a state in which a screen, which requires (or receives) an identification of a contact point on one surface at a displaying area formed by the projection assembly, is projected. For example, the electronic device may identify the screen requiring the identification of the contact point based on a software application associated with the screen. The electronic device may identify the screen requiring the identification of the contact point based on instructions included in the software application. The electronic device may activate a camera positioned toward a second direction different from a first direction of the projection assembly in a state in which the screen requiring the identification of the contact point is projected.

In an operation 905, according to an embodiment, the electronic device may identify an external object from information obtained by using the activated camera. For example, the information may include images obtained by using the camera. The electronic device may change a size of a screen in response to identifying the external object from the information obtained by using the activated camera. For example, the electronic device may change the size of the screen based on a location of the external object with respect to the surface in response to identifying the external object. For example, the electronic device may move the screen to an area corresponding to the location of the external object or change the size of the screen.

As described above, according to an embodiment, the electronic device may activate the camera in a state in which a screen requiring the identification of the contact point is projected. The electronic device may deactivate the camera in the second state different from the first state. The electronic device may identify the external object from the information obtained by using the activated camera in the first state. In response to identifying the external object, the electronic device may change the size of the screen based on the location of the external object with respect to the surface on which the screen is projected. The electronic device may enhance a user experience of the electronic device by changing the size of the screen based on the location of the external object.

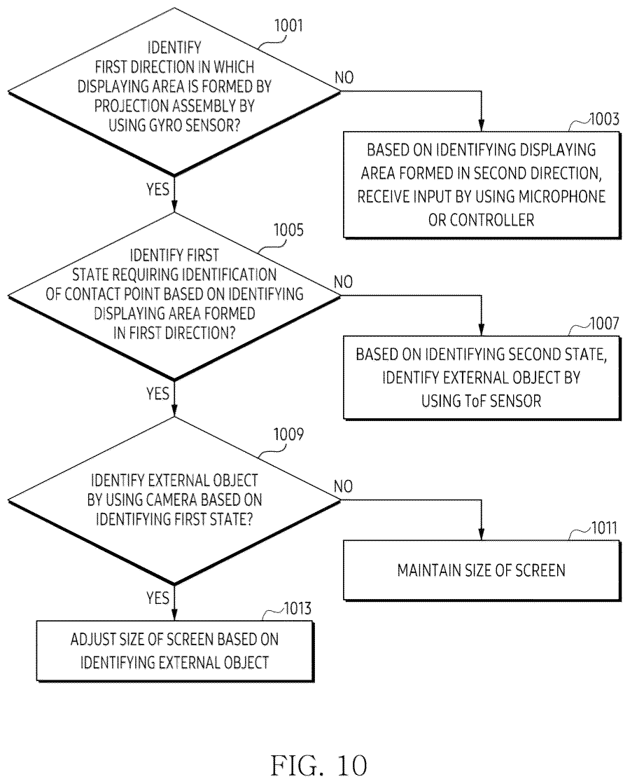

FIG. 10 illustrates an example of a flowchart of an operation of an electronic device according to an embodiment. The electronic device of FIG. 10 may include the electronic device 101 of FIG. 1, 2, 3A, 3B, 3C, 4, 5, 6, 7, and/or 8, and/or the electronic device of FIG. 9. Operations of FIG. 10 may be performed by the processor 210 of FIG. 2.

Referring to FIG. 10, in an operation 1001, according to an embodiment, the electronic device may identify a first direction in which a displaying area is formed by a projection assembly (e.g., the projection assembly 120 of FIG. 2) by using a gyro sensor (e.g., the gyro sensor 231 of FIG. 2). For example, the electronic device 101 may identify the first direction in which the projection assembly faces, based on information (or data) obtained from the gyro sensor. For example, the first direction may include a direction toward a wall or toward the ground.

In a case that the first direction in which the displaying area is formed by the projection assembly is not identified (operation 1001—NO), in an operation 1003, according to an embodiment, the electronic device may identify a displaying area formed in a second direction different from the first direction. For example, the second direction may include a direction toward the ceiling. According to an embodiment, the electronic device 101 may project a screen into the displaying area formed in the second direction. The electronic device may receive a voice signal through a microphone (e.g., the microphone 250 of FIG. 2) while projecting the screen into the displaying area formed in the second direction. The electronic device may perform an operation corresponding to the voice signal based on the reception of the voice signal. According to an embodiment, the electronic device may receive an input based on an external electronic device (e.g., a controller) while projecting the screen into the displaying area formed in the second direction. For example, the electronic device may receive the input indicating to select visual objects projected into the screen by the external electronic device. The electronic device may perform an operation corresponding to the input based on receiving the input.

In a case that the first direction in which the displaying area is formed by the projection assembly is identified (operation 1001—YES), in an operation 1005, according to an embodiment, the electronic device may identify whether it is a first state requiring identification of a contact point or not, based on identifying the displaying area formed in the first direction. For example, the first state may include a state in which a screen requiring the identification of the contact point on one surface at which the displaying area is formed is projected. For example, the electronic device may identify the screen requiring the identification of the contact point based on information (or data) transmitted from an interface. The electronic device may identify the screen requiring the identification of the contact point based on instructions associated with a layout of the screen included in the information. According to an embodiment, the second state may be a state different from the first state in which the screen requiring the identification of the contact point is projected.

In a case that the first state requiring the identification of the contact point based on identifying the displaying area formed in the first direction is not identified (operation 1005—NO), in an operation 1007, according to an embodiment, the electronic device may identify the second state different from the first state. The electronic device may identify an external object, by using a ToF sensor (e.g., the ToF sensor 232 of FIG. 2) in the second state. For example, the electronic device may include one or more ToF sensors. The electronic device may identify a gesture (or a motion) of the external object, by using the one or more ToF sensors. The electronic device may identify a preset gesture based on the ToF sensor. The electronic device may perform an operation corresponding to the preset gesture based on identifying the preset gesture. For example, the operation corresponding to the preset gesture may include an operation of executing a media content.

In a case that the first state requiring the identification of the contact point based on identifying the displaying area formed in the first direction is identified (operation 1005—YES), in an operation 1009, according to an embodiment, the electronic device may identify the external object by using a camera (e.g., camera 220 of FIG. 2) based on identifying the first state. For example, the electronic device may identify a location of the external object by using a camera including a fisheye lens. The electronic device may identify the location of the external object with respect to the surface at which the displaying area is formed.

In a case that the external object is not identified by using the camera based on identifying the first state (operation 1009—NO), in an operation 1011, according to an embodiment, the electronic device may maintain a size of the screen projected by the projection assembly. For example, the electronic device may maintain the size of the screen while projecting the screen requiring the identification of the contact point in the first state.

In a case that the external object is identified by using the camera based on identifying the first state (operation 1009—YES), in an operation 1013, according to an embodiment, the electronic device may adjust a size of the displaying area based on identifying the external object. According to an embodiment, the electronic device may identify the location of the external object by using the camera. For example, the electronic device may identify the location of the external object with respect to the surface at which the displaying area is formed. The electronic device may project the screen to an area corresponding to the location based on identifying the location of the external object. For example, the electronic device may adjust the size of the screen when projecting the screen to the area corresponding to the location. For example, the electronic device may identify the location of the external object and a portion (e.g., an eye of a user) of the external object. The electronic device may project the screen into a displaying area corresponding to the location of the external object and the portion of the external object. For example, the electronic device may reduce the size of the screen based on a field-of-view of the external object identified based on the portion of the external object.

As described above, according to an embodiment, the electronic device may identify a direction in which the screen is projected based on data obtained by using the gyro sensor. The electronic device may identify the first state requiring the identification of the contact point or the second state different from the first state based on the direction in which the screen is projected. The electronic device may identify the external object using the ToF sensor based on identifying the second state. The electronic device may identify the external object using the camera based on identifying the first state. The electronic device may identify the external object using a different component based on each state. The electronic device may efficiently manage power consumption by identifying the external object using the different component based on each state.

Metaverse is a compound word of the English words “Meta” meaning “virtual” and “transcendence” and “Universe” meaning cosmos, and refers to a three-dimensional virtual world in which social, economic, and cultural activities take place like a real world. Metaverse is a concept that has evolved one step further than a virtual reality (VR, cutting-edge technology that enables people to experience real-life experiences in a virtual world created by a computer), and it is characterized by using avatars to not only enjoy games or virtual reality, but also social and cultural activities like a reality. A metaverse service may provide media content for enhancing immersion in the virtual world, based on an augmented reality (AR), a virtual reality environment (VR), a mixed environment (MR), and/or an extended reality (XR).

For example, media content provided by the metaverse service may include social interaction content including avatar-based game, concert, party, and/or meeting. For example, the media content may include information for economic activities such as advertising, user created content, and/or sales and/or shopping of productions. Ownership of the user created content may be proved by a blockchain-based non-fungible token (NFT). The metaverse service may support economic activities based on real money and/or cryptocurrency. By the metaverse service, virtual content associated with the real world, such as digital twin or life logging, may be provided.

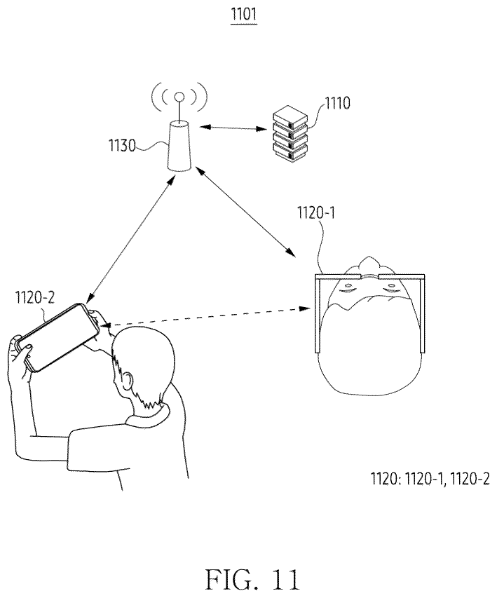

FIG. 11 is an example diagram of a network environment 2001 in which a metaverse service is provided through a server 2010.

Referring to FIG. 11, a network environment 1101 may include a server 1110, a user terminal 1120 (e.g., a first terminal 1120-1 and a second terminal 1120-2), and a network connecting the server 1110 and the user terminal 1120. In the network environment 1101, the server 1110 may provide a metaverse service to the user terminal 1120. The network may be formed by at least one intermediate node 1130 including an access point (AP) and/or a base station. The user terminal 1120 may access the server 1110 through the network and output a user interface (UI) associated with a metaverse service to a user of the user terminal 1120. Based on the UI, the user terminal 1120 may obtain information to be inputted into the metaverse service from the user, or output information (e.g., multimedia content) associated with the metaverse service to the user.

In this case, the server 1110 provides a virtual space so that the user terminal 1120 may perform activities in the virtual space. In addition, the user terminal 1120 may represent information provided by the server 1110 to the user by installing an S/W agent to access the virtual space provided by the server 1110, or transmit information that the user wants to represent in the virtual space to the server. The S/W agent may be provided directly through the server 1110, downloaded from a public server, or embedded and provided when purchasing a terminal.

In an embodiment, the metaverse service may provide a service to the user terminal 1120 and/or a user by using the server 1110. The embodiment is not limited thereto, and the metaverse service may be provided through individual contacts between users. For example, in the network environment 1101, the metaverse service may be provided by a direct connection between the first terminal 1120-1 and the second terminal 1120-2, independently of the server 1110. Referring to FIG. 11, in the network environment 1101, the first terminal 1120-1 and the second terminal 1120-2 may be connected to each other through a network formed by at least one intermediate node 1130. In an embodiment in which the first terminal 1120-1 and the second terminal 1120-2 are directly connected, any one of the first terminal 1120-1 and the second terminal 1120-2 may perform a role of the server 1110. For example, a metaverse environment may be configured only with a device-to-device connection (e.g., a peer-to-peer (P2P) connection).

In an embodiment, the user terminal 1120 (or the user terminal 1120 including the first terminal 1120-1 and the second terminal 1120-2) may be made in various form factors, and it is characterized by including an output device for providing an image and/or sound to the user and an input device for inputting information into the metaverse service. An example user terminal 1120 in various form factors may include a smartphone (e.g., the second terminal 1120-2), an AR device (e.g., the first terminal 1120-1), a VR device, an MR device, a Video See Through (VST) device, an Optical See Through (OST) device, a smart lens, a smart mirror, a TV capable of inputting and outputting, or a projector.

A network (e.g., a network formed by at least one intermediate node 2030) includes all of various broadband networks including 3G, 4G, and 5G and short-range networks (e.g., a wired network or a wireless network that directly connects the first terminal 1120-1 and the second terminal 1120-2) including Wi-Fi and BT.

According to an embodiment, the user terminal 1120 of FIG. 11 may include the electronic device 101 of FIGS. 1, 2, 3A, 3B, 3C, 4, 5, 6, 7, and/or 8.

Based on a media content projected onto a screen, a method to change a size of the screen may be required. An electronic device 101 may comprise an interface, a camera 220, a projection assembly 120, the one or more processors 210. The one or more processors 210 may project, by controlling the projection assembly 120, a screen obtained through the interface. The one or more processors 210 may activate, in a state of projecting the screen requiring identification of a contact point on one surface at a displaying area formed by the projection assembly 120, the camera 220 positioned toward a second direction different from a first direction of the projection assembly 120. The one or more processors 210 may change, in response to identifying an external object 105 from information obtained using the activated camera 220, a size of the screen based on a location of the external object 105 with respect to the surface 310.

According to an embodiment, the one or more processors 210 may identify, based on the camera 220, an input of the external object 105 with respect to the screen.

According to an embodiment, the one or more processors 210 may identify a distance between a portion of the external object 105 and the surface 310 using the camera 220. The one or more processors 210 may identify, based on identifying the distance, the contact point.

According to an embodiment, the one or more processors 210 may comprise a gyro sensor 231. The processor 210 may identify, based on the gyro sensor 231, the state in which the screen requiring the identification of the contact point is projected.

According to an embodiment, the one or more processors 210 may execute, based on identifying a preset motion of the external object 105, a second software application different from a first software application to project the screen. The one or more processors 210 may project a first screen associated with the first software application and a second screen associated with the second software application.

According to an embodiment, the one or more processors 210 may project, based on identifying a distance shorter than a preset threshold distance between the external object 105 and the surface 310 in a state of projecting the first screen and the second screen, visual objects associated with termination of the first software application and the second software application.

According to an embodiment, the one or more processors 210 may cease to, based on identifying a distance longer than or equal to the preset threshold distance between the external object 105 and the surface 310, project the visual objects associated with the termination.

According to an embodiment, the one or more processors 210 may adjust, based on a border line formed between the first screen and the second screen, a size of the first screen and the second screen.

According to an embodiment, the electronic device 101 may comprise a gyro sensor 231, and a time-of-flight (ToF) sensor 232. The one or more processors 210 may identify, in a second state different from the state which is a first state, the external object 105 using the ToF sensor based on a first direction of the projection assembly 120 identified based on the gyro sensor 231.

As described above, according to an embodiment, a method of an electronic device 101 may comprise projecting, by controlling a projection assembly 120, a screen obtained through an interface. The method of the electronic device 101 may comprise activating, in a state of projecting the screen requiring identification of a contact point on one surface at a displaying area formed by the projection assembly 120, a camera 220 positioned toward a second direction different from a first direction of the projection assembly 120. The method of the electronic device 101 may comprise changing, in response to identifying an external object 105 from information obtained using the activated camera 220, a size of the screen based on a location of the external object 105 with respect to the surface 310.

According to an embodiment, the method of the electronic device 101 may comprise identifying, based on the camera 220, an input of the external object 105 with respect to the screen.

According to an embodiment, the method of the electronic device 101 may comprise identifying a distance between a portion of the external object 105 and the surface 310 using the camera 220. The method of the electronic device may comprise identifying, based on identifying the distance, the contact point.

According to an embodiment, the method of the electronic device 101 may comprise identifying, based on a gyro sensor 231, the state in which the screen requiring the identification of the contact point is projected.

According to an embodiment, the method of the electronic device 101 may execute, based on identifying a preset motion of the external object 105, a second software application different from a first software application to project the screen. The method of the electronic device 101 may comprise projecting a first screen associated with the first software application and a second screen associated with the second software application.

According to an embodiment, the method of the electronic device 101 may comprise projecting, based on identifying a distance shorter than a preset threshold between the external object 105 and the surface 310 in a state of projecting the first screen and the second screen, a visual object associated with termination of the first software application and the second software application.

According to an embodiment, the method of the electronic device 101 may comprise ceasing to, based on identifying a distance longer than or equal to the preset threshold between the external object 105 and the surface 310, project the visual object associated with the termination.

According to an embodiment, the method of the electronic device 101 may comprise adjusting, based on a border line formed between the first screen and the second screen, a size of the first screen and the second screen.

According to an embodiment, the method of the electronic device 101 may comprise identifying, in a second state different from the state which is a first state, the external object 105 using a ToF sensor based on a first direction of the projection assembly 120 identified based on a gyro sensor 231.

As described above, according to an embodiment, in a computer readable storage medium storing one or more programs, the one or more programs, when executed by a processor 210 of an electronic device 101, may cause the processor 210 of the electronic device 101 to project, by controlling a projection assembly 120, a screen obtained through an interface. The one or more programs, when executed by the processor 210 of the electronic device 101, may cause the processor 210 of the electronic device 101 to activate, in a state of projecting the screen requiring identification of a contact point on one surface at a displaying area formed by the projection assembly 120, a camera 220 positioned toward a second direction different from a first direction of the projection assembly 120. The one or more programs may cause the processor 210 of the electronic device 101 to change, in response to identifying an external object 105 from information obtained using the activated camera 220, a size of the screen based on a location of the external object 105 with respect to the surface 310.

According to an embodiment, the one or more programs, when executed by the processor 210 of the electronic device 101, may cause the processor 210 of the electronic device 101 to identify, based on the camera 220, an input of the external object 105 with respect to the screen.

According to an embodiment, the one or more programs, when executed by the processor 210 of the electronic device 101, may cause the processor 210 of the electronic device 101 to identify a distance between a portion of the external object 105 and the surface 310 using the camera 220. The one or more programs, when executed by the processor 210 of the electronic device 101, may cause the processor 210 of the electronic device 101 to identify, based on identifying the distance, the contact point.

According an embodiment, the one or more programs, when executed by the processor 210 of the electronic device 101, may cause the processor 210 of the electronic device 101 to identify, based on a gyro sensor 231, the state in which the screen requiring the identification of the contact point is projected.

According to an embodiment, the one or more processors, when executed by the processor 210 of the electronic device 101, may cause the processor 210 of the electronic device 101 to execute, based on identifying a preset motion of the external object 105, a second software application different from a first software application to project the screen. The one or more processors 210, when executed by the processor 210 of the electronic device 101, may cause the processor 210 of the electronic device 101 to project a first screen associated with the first software application and a second screen associated with the second software application.

According to an embodiment, the one or more processors 210, when executed by the processor 210 of the electronic device 101, may cause the processor 210 of the electronic device 101 to project, based on identifying a distance shorter than a preset threshold distance between the external object 105 and the surface 310 in a state of projecting the first screen and the second screen, a visual object associated with termination of the first software application and the second software application.

According to an embodiment, the one or more processors 210, when executed by the processor 210 of the electronic device 101, may cause the processor 210 of the electronic device 101 to cease to, based on identifying a distance longer than or equal to the preset threshold distance between the external object 105 and the surface 310, project the visual object associated with the termination.

According to an embodiment, the one or more processors 210, when executed by the processor 210 of the electronic device 101, may cause the processor 210 of the electronic device 101 to adjust, based on a border line formed between the first screen and the second screen, a size of the first screen and the second screen.

According to an embodiment, the one or more processors 210, when executed by the processor 210 of the electronic device 101, may cause the processor 210 of the electronic device 101 to identify, in a second state different from the state which is a first state, the external object 105 using a ToF sensor based on a first direction of the projection assembly 120 identified based on a gyro sensor 231

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

One or more embodiments as set forth herein may be implemented as software including one or more instructions that are stored in a storage medium that is readable by a machine (e.g., the electronic device 101). For example, a processor (e.g., the processor 210) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
an interface;
a camera;
a projection assembly;
memory comprising one or more storage media storing instructions; and
at least one more processor comprising processing circuitry,
wherein the instructions, when executed by the at least one processor individually or collectively, cause the electronic device to:
project, by controlling the projection assembly, a screen obtained through the interface;
activate, in a state of projecting the screen receiving an identification of a contact point on a surface at a displaying area formed by the projection assembly, the camera positioned toward a second direction different from a first direction of the projection assembly; and
based on identifying an external object from information obtained using the activated camera, change a size of the screen based on a location of the external object with respect to the surface.

2. The electronic device of claim 1, wherein the instructions, when executed by the at least one processor individually or collectively, cause the electronic device to identify, using the camera, an input of the external object with respect to the screen.

3. The electronic device of claim 2, wherein the instructions, when executed by the at least one processor individually or collectively, cause the electronic device to:
identify, using the camera, a distance between a portion of the external object and the surface; and
based on identifying the distance, identify the contact point.

4. The electronic device of claim 1, further comprising a gyro sensor,
wherein the instructions, when executed by the at least one processor individually or collectively, cause the electronic device to, identify, using the gyro sensor, the state in which the screen requiring the identification of the contact point is projected.

5. The electronic device of claim 1, wherein the instructions, when executed by the at least one processor individually or collectively, cause the electronic device to:
based on identifying a preset motion of the external object, execute a second software application different from a first software application to project the screen; and
project a first screen associated with the first software application and a second screen associated with the second software application.

6. The electronic device of claim 5, wherein the instructions, when executed by the at least one processor individually or collectively, cause the electronic device to based on identifying a distance shorter than a preset threshold distance between the external object and the surface in a state of projecting the first screen and the second screen, project visual objects associated with a termination of the first software application and the second software application.

7. The electronic device of claim 6, wherein the instructions, when executed by the at least one processor individually or collectively, cause the electronic device to based on identifying a distance longer than or equal to the preset threshold distance between the external object and the surface, cease to project the visual objects associated with the termination of the first software application and the second software application.

8. The electronic device of claim 5, wherein the instructions, when executed by the at least one processor individually or collectively, cause the electronic device to adjust, based on a border line between the first screen and the second screen, a first size of the first screen and a second size of the second screen.

9. The electronic device of claim 1, further comprising:
a gyro sensor; and
a time-of-flight (ToF) sensor,
wherein the instructions, when executed by the at least one processor individually or collectively, cause the electronic device to identify, in a second state different from the state which is a first state, the external object, using the ToF sensor, based on the first direction of the projection assembly identified by the gyro sensor.

10. A method of an electronic device, the method comprising:
projecting, by controlling a projection assembly of the electronic device, a screen obtained through an interface of the electronic device;
activating, in a state of projecting the screen receiving an identification of a contact point on a surface at a displaying area formed by the projection assembly, a camera of the electronic device positioned toward a second direction different from a first direction of the projection assembly; and
based on identifying an external object from information obtained using the activated camera, changing a size of the screen based on a location of the external object with respect to the surface.

11. The method of claim 10, further comprising identifying, using the camera, an input of the external object with respect to the screen.

12. The method of claim 11, further comprising:
identifying, using the camera, a distance between a portion of the external object and the surface; and
based on identifying the distance, identifying the contact point.

13. The method of claim 10, further comprising identifying, using a gyro sensor of the electronic device, the state in which the screen receiving the identification of the contact point is projected.

14. The method of claim 10, further comprising:
based on identifying a preset motion of the external object, executing a second software application different from a first software application to project the screen; and
projecting a first screen associated with the first software application and a second screen associated with the second software application.

15. The method of claim 14, further comprising based on identifying a distance shorter than a preset threshold between the external object and the surface in a state projecting the first screen and the second screen, projecting a visual object associated with a termination of the first software application and the second software application.

16. The method of claim 15, further comprising based on identifying a distance longer than or equal to the preset threshold between the external object and the surface, ceasing the projecting the visual object associated with the termination of the first software application and the second software application.

17. The method of claim 14, further comprising adjusting, based on a border line formed between the first screen and the second screen, a first size of the first screen and a second size of the second screen.

18. The method of claim 10, further comprising identifying, in a second state different from the state which is a first state, the external object, using a time-of-flight (ToF) sensor of the electronic device, based on the first direction of the projection assembly identified by a gyro sensor of the electronic device.

19. A non-statutory computer readable storage medium storing one or more programs, wherein the one or more programs, when executed by a processor of an electronic device, cause the processor of the electronic device to:
project, by controlling a projection assembly of the electronic device, a screen obtained through an interface;
activate, in a state projecting the screen receiving an identification of a contact point on a surface at a displaying area formed by the projection assembly, a camera of the electronic device positioned toward a second direction different from a first direction of the projection assembly; and
based on identifying an external object from information obtained using the activated camera, change a size of the screen based on a location of the external object with respect to the surface.

20. The non-statutory computer readable storage medium of claim 19, wherein the one or more programs, when executed by the processor of the electronic device, cause the electronic device to identify, based on the camera, an input of the external object with respect to the screen.
